(19) United States
(12) Patent Application Publication
(10) Pub. No.: US 2025/0024442 A1
(43) Pub. Date: Jan. 16, 2025

(54) NETWORK NODE, USER EQUIPMENT AND METHODS PERFORMED THEREIN

(71) Applicant: Telefonaktiebolaget LM Ericsson (publ), Stockholm (SE)

(72) Inventors: Niklas ANDGART, Södra Sandby (SE); Junaid ANSARI, Aachen (DE); Sara SANDBERG, Luleå (SE)

(21) Appl. No.: 18/575,995

(22) PCT Filed: Jul. 5, 2021
(86) PCT No.: PCT/SE2021/050678

§ 371 Date: Jan. 2, 2024

(51) Int. Cl. H04W 72/0453; H04W 72/543; H04W 76/15

(52) U.S. Cl. CPC H04W 72/0453; H04W 72/543; H04W 76/15

(57) ABSTRACT

A method performed by a network node for transmitting data to a UE in a communication network. The network node selects at least one first frequency band for transmission of the data, when a quality of the first frequency band is above a threshold value. The network node further selects at least one second frequency band for a transmission of the data, based on a sequence, wherein the sequence is based on a dynamically adjustable configuration.

### TECHNICAL FIELD

Embodiments herein relate to a network node, a user equipment (UE) and methods performed therein. Furthermore, a computer program and a computer readable storage medium are also provided herein. In particular, embodiments herein relate to handling communication of data between the UE and the network node in a communication network.

### BACKGROUND

In a typical communication network, UEs, also known as wireless communication devices, mobile stations, stations (STA) and/or wireless devices, communicate via a Radio Access Network (RAN) to one or more core networks (CNs). The RAN covers a geographical area which is divided into service areas or cell areas, with each service area or cell area being served by a radio network node such as a radio access node e.g., a Wi-Fi access point or a radio base station (RBS), which in some networks may also be denoted, for example, a NodeB, an eNodeB″, or a gNodeB. A service area or cell area is a geographical area where radio coverage is provided by the radio network node. The radio network node communicates over an air interface operating on radio frequencies with the wireless device within range of the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for user equipment. In a forum known as the Third Generation Partnership Project (3GPP), telecommunications suppliers propose and agree upon standards for third generation networks, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS) have been completed within the 3GPP and this work continues in the coming 3GPP releases. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a variant of a 3GPP radio access technology wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes which can be connected directly to one or more core networks, i.e. they do not need to be connected to the core via RNCs.

With the emerging 5G technologies such as New Radio (NR), the use of a large number of transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify received signals coming from a selected direction or directions, while suppressing received unwanted signals coming from other directions.

Ultra-Reliable Low-Latency Communication (URLLC) can be defined as a set of features that provide low latency and ultra-high reliability for mission critical applications such as industrial internet, smart grids, remote surgery and intelligent transportation systems, etc.

With URLLC type of traffic, there are high requirements on reliability, with errors allowed to happen very seldom, if at all. Different forms of increasing redundancy can be employed, but even if performance is validated according to a certain model, there may still be a risk that reality does not follow the model due to e.g. that a jammer may be present, that other systems may be malfunctioning causing aggressive interference, wireless channel propagation issues such as a deep fading situation, etc. In such circumstances, the wide frequency ranges in unlicensed frequency bands, e.g. 1.2 GHz in the 6 GHz frequency band or in Millimeter Wave (mmW) bands, seem to be attractive ways of increasing the transmission redundancy and solutions of how to choose frequency bands, i.e. carriers such as spectrum bandwidth or frequency portions, are needed.

### SUMMARY

An object of embodiments herein is to provide a mechanism for handling communication of a UE in a communication network in an efficient and reliable manner.

According to an aspect of embodiments herein the object is achieved by a method performed by a network node for handling communication of data in a communication network. The network node selects at least one first frequency band for transmission of the data, when a quality of the first frequency band is above a threshold value. The network node further selects at least one second frequency band for a transmission of the data, based on a sequence, wherein the sequence is based on a dynamically adjustable configuration.

According to a further aspect of embodiments herein the object is achieved by a method performed by a UE for handling communication of data in a communication network. The UE receives information, from a network node, of which of at least one first frequency band and at least one second frequency band that have been selected, wherein the at least one second frequency band is based on a sequence, and wherein the sequence is based on a dynamically adjustable configuration. The UE further transmits the data over the selected at least one first frequency band and the selected at least one second frequency band.

According to another aspect of embodiments herein, the object is achieved by providing a network node for handling communication of data in a communication network. The network node is configured to select at least one first frequency band for transmission of the data, when a quality of the first frequency band is above a threshold value. The network node is further configured to select at least one second frequency band for a transmission of the data, based on a sequence, wherein the sequence is based on a dynamically adjustable configuration.

According to yet another aspect of embodiments herein, the object is achieved by providing a UE for handling communication of data in a communication network. The UE is configured to receive information, from a network node, of which of at least one first frequency band and at least one second frequency band that have been selected, wherein the at least one second frequency band is based on a sequence, and wherein the sequence is based on a dynamically adjustable configuration. The UE is further configured to transmit the data over the selected at least one first frequency band and the selected at least one second frequency band.

It is furthermore provided herein a computer program comprising instructions, which, when executed on at least one processor, cause the at least one processor to carry out the methods above, as performed by the network node or the UE, respectively. It is additionally provided herein a computer-readable storage medium, having stored thereon a computer program comprising instructions which, when executed on at least one processor, cause the at least one processor to carry out the methods above, as performed by the network node or the UE, respectively.

Embodiments herein are based on the realisation that to increase reliability, dynamic frequency selection and aggregation may be used with transmission of the same data over more than one frequency band at the same time. Accordingly, by selecting at least one first frequency band for transmission of the data, when a quality of the first frequency band is above a threshold value and selecting a second frequency band for transmission of the data, based on a sequence, the communication of the UE in the communication network is handled in a more efficient manner.

### BRIEF DESCRIPTION OF THE DRAWINGS

Embodiments will now be described in more detail in relation to the enclosed drawings, in which:

FIG. 1 is a schematic overview depicting a communication network according to embodiments herein;

FIG. 2 is a flowchart depicting a method performed by a network node according to embodiments herein;

FIG. 3 is a schematic overview illustrating a frequency band selection based on a sequence according to embodiments herein;

FIG. 4 is a flowchart depicting a method performed by a UE according to embodiments herein;

FIG. 5 is a block diagram depicting a network node according to embodiments herein;

FIG. 6 is a block diagram depicting a UE according to embodiments herein; schematically illustrates a telecommunication network connected via an FIG. 7 intermediate network to a host computer;

FIG. 8 is a generalized block diagram of a host computer communicating via a base station with a user equipment over a partially wireless connection; and

FIGS. 9 to 12 are flowcharts illustrating methods implemented in a communication system including a host computer, a base station and a user equipment.

### DETAILED DESCRIPTION

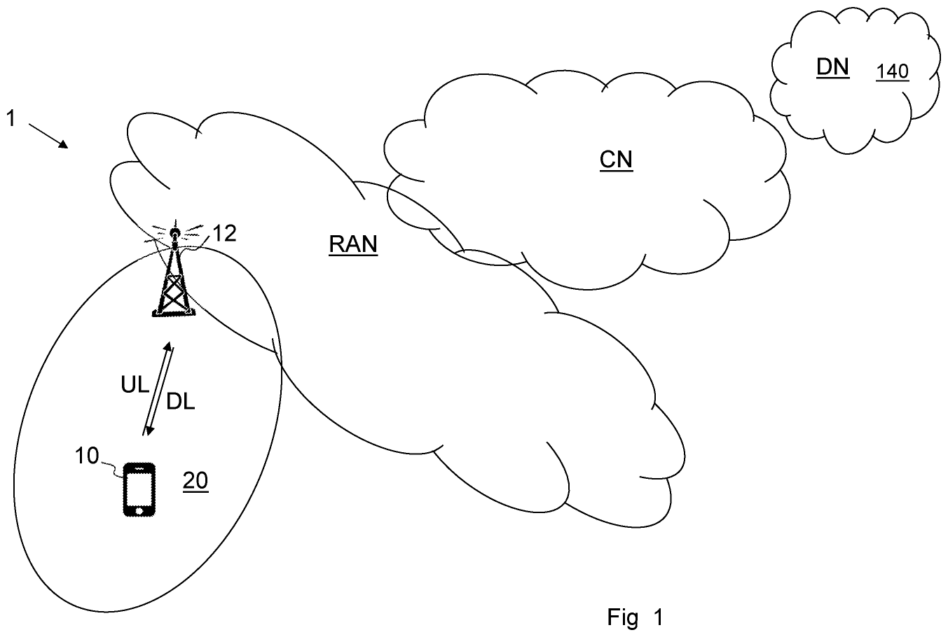

Embodiments herein relate to communication networks in general. FIG. 1 is a schematic overview depicting a communication network 1. The communication network 1 comprises one or more RANs connected to one or more CNs. The communication network 1 may use a number of different technologies, such as Wi-Fi, Long Term Evolution (LTE), LTE-Advanced, 5G, Wideband Code Division Multiple Access (WCDMA), Global System for Mobile communications/Enhanced Data rate for GSM Evolution (GSM/EDGE), Worldwide Interoperability for Microwave Access (WiMAX), or Ultra Mobile Broadband (UMB), just to mention a few possible implementations. Embodiments herein relate to recent technology trends that are of particular interest in a 5G context, however, embodiments are applicable also in further development of the existing communication systems such as e.g. a WCDMA and or LTE system.

In the communication network 1, wireless devices e.g. a UE 10 such as a mobile station, a non-access point (non-AP) station (STA), a STA, a user equipment and/or a wireless terminal, communicate via one or more Access Networks (AN), e.g. RAN, to one or more CNs. It should be understood by the skilled in the art that “UE” is a non-limiting term which means any terminal, wireless communication terminal, user equipment, Machine Type Communication (MTC) device, Device to Device (D2D) terminal, internet of things (IoT) operable device, or node e.g. smart phone, laptop, mobile phone, sensor, relay, mobile tablets or even a small base station capable of communicating using radio communication with a network node within an area served by the network node.

The communication network 1 comprises a network node 12, e.g. a radio network node, providing e.g. radio coverage over a geographical area, a first service area 20 i.e. a first cell, of a radio access technology (RAT), such as NR, LTE, Wi-Fi, WiMAX or similar. The network node 12 may be a transmission and reception point, a computational server, a base station e.g. a network node such as a satellite, a Wireless Local Area Network (WLAN) access point or an Access Point Station (AP STA), an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g. on the radio access technology and terminology used. The network node 12 may alternatively or additionally be a controller node or a packet processing node or similar. The network node 12 may be referred to as source node, source access node or a serving network node wherein the first service area 20 may be referred to as a serving cell, source cell or primary cell, and the network node communicates with the UE 10 in form of DL transmissions to the UE 10 and UL transmissions from the UE 10. The network node 12 may be a target node. The network node 12 may be a distributed node comprising a baseband unit and one or more remote radio units. It should be noted that a service area may be denoted as cell, beam, beam group or similar to define an area of radio coverage.

According to embodiments herein the network node 12 selects at least one first frequency band for transmission of data, when a quality of the first frequency band is above a threshold value. The network node further selects at least one second frequency band for the transmission of the data, based on a sequence.

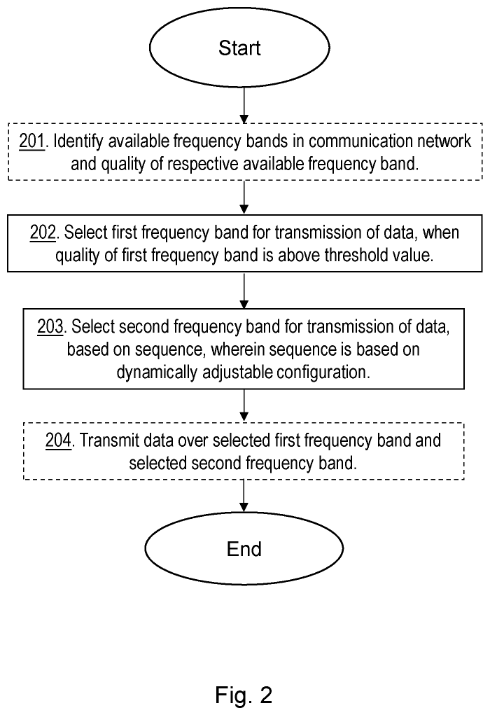

The method actions performed by the network node 12 for handling communication of the data, for example, between the UE 10 and the network node 12, in the communication network 1, according to embodiments herein, will now be described with reference to a flowchart depicted in FIG. 2. The actions do not have to be taken in the order stated below but may be taken in any suitable order. Actions performed in some embodiments are marked with dashed boxes.

### Action 201

To enable the frequency band selection the network node 12 needs to know which frequency bands that are available for selection to transmit the data on. Therefore, the network node 12 first identifies available frequency bands in the communication network 1. The available frequency bands may be identified by using a semi static configuration. The available frequency bands may also be identified by predefining them in a product or if they are configured in the UE settings or are configurable in the UE software.

Also, the network node 12 needs to know the quality of the available frequency bands as this will be used as a criterion for the selection of the frequency band. Therefore, the network node 12 may also identify a quality of the respective available frequency band. The quality of the respective available frequency band may be associated with one or more of: a lower degree of occupancy, a historically observed higher reliability, a local deployment spectrum policy and traffic Quality-of-Service (QoS) requirements. The traffic QoS requirements may be useful in the context for determining how much redundancy, e.g. dynamic band selection and bandwidth selection that is governed. For instance, if there is more redundancy needed, e.g. a higher reliability target, more combinations may be needed, and vice-versa.

### Action 202

As the network node 12 now knows which frequency bands in the communication network that are available and also knows the quality of the available frequency bands, the network node 12 selects the at least one first frequency band for transmission of the data, when the quality of the at least one first frequency band is above the threshold value, e.g. the threshold value may be medium quality. The at least one frequency band may be used for robust performance.

### Action 203

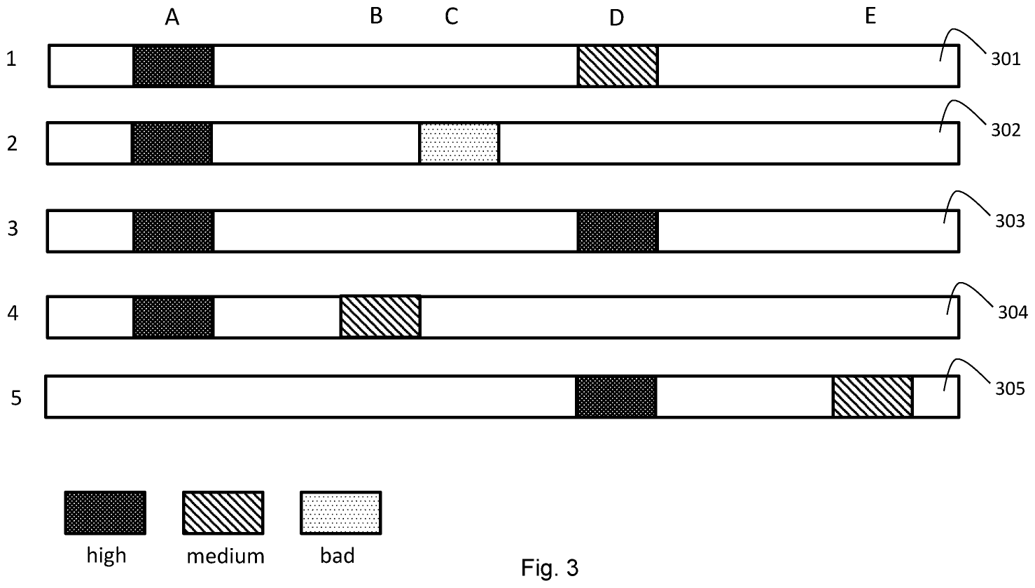

The network node 12 further selects the at least one second frequency band for transmission of the data, based on the sequence, wherein the sequence is based on a dynamically adjustable configuration. E.g. depending on reliability and/or interference in the at least one second frequency band, the sequence will be dynamically adapted based on this. An example of a sequence that is based on dynamically adjustable configuration of the at least one second frequency band, will later be described in FIG. 3 below. The sequence may be known to both the UE 10 and the network node 12. According to some embodiments, the sequence may be dynamically adjusted when a condition is fulfilled or not, wherein the condition may be based on the quality and a knowledge of available frequency bands. As the condition may be based on the quality of the available frequency bands, e.g. probing of the second frequency bands may also be measured for quality, it enables to build up a knowledge about quality and availability and to keep this information up to date. According to some embodiments, the sequence may be semi-static, wherein at least a part of the sequence can be reused. This means that the sequence may further be based on a set configuration, i.e. the sequence may be based on a dynamically adjustable configuration and/or a set configuration, wherein the combination is a semi-static configuration. This is advantageous because dynamic configuration and semi-static configuration, as opposed to static configuration, is more secure and can be agreed/determined/assigned based on the specific requirements of the number of terminals, available spectrum resource, mobility and dynamism in the number of UEs attached at a given point of time with the network node 12.

The at least one frequency band may be used for robust performance and the at least one second frequency band may be used for probing. The at least one first frequency band and/or the at least one second frequency band may be a licensed carrier and/or an unlicensed carrier.

According to some embodiments, the network node 12 may inform the UE 10 of which of the first frequency bands and second frequency bands that are selected. This is advantageous as the network node 12 may better dimension the resource availability, traffic loads from different UEs with specific QoS profiles and spectrum interference situations. The network node 12 tends to have a better overall network picture on the traffic loads, QoS requirements, active UEs, spectrum conditions, etc. According to some embodiments, the network node 12 informs the UE 10 about the sequence of frequency bands, or parameters specifying the sequence of frequency bands. This is advantageous because the sequence may be needed for rendezvous situations, i.e. the UE 10 may need to tune to the frequency band, e.g. frequency portion, where the transmission is carried out at a specific time. This also relates to the general broad information available at the network node 12 about the resource availability, traffic loads from different UEs with specific QoS profiles and spectrum interference situation.

According to some embodiments a bandwidth of the first frequency bands and the second frequency bands may be different. The bandwidth of the first frequency bands may be different, and/or wherein the bandwidth of the second frequency bands may be different. This is advantageous as bandwidth assignment in a dynamic fashion allows to utilize spectrum holes, i.e., portions of available frequency resources, at a given time more efficiently and as per the traffic load and QoS requirements. For smaller traffic load, less frequency resources suffice, and vice-versa. Also, the frequency resource availability can be dynamic and being able to dynamically adjust to the variable, and small bandwidth portions increases the spectrum utilization efficiency. If the transmission can sneak out in even small portions of the frequency spectrum in a dynamic fashion, the spectrum is utilized better.

### Action 204

The idea is to transmit the same data over the at least two frequency bands to achieve reliability. The network node 12 may therefore transmit the data over the selected at least one first frequency band and the selected at least one second frequency band. The data may be transmitted simultaneously over the at least one first frequency band and the at least one second frequency band. The number of frequency bands used for data transmission, e.g. simultaneous transmission of the same data, may vary depending on the reliability requirements of the transmission as well as the quality of the frequency bands used. The data may be transmitted uplink and/or downlink. The data transmission may be based on reliability requirements, e.g. URLLC requirements, and/or the quality of the available frequency bands.

An advantage of embodiments herein is that by using the dynamically selected sequence instead of a pre-defined hopping sequence in the large available spectrum, it allows for frequency bands to be selected that show a lower degree of occupancy, a historically observed higher reliability, local deployment spectrum policies, etc. Moreover, the solution according to embodiments herein is more adaptive to the spectrum situation and QoS requirements when introducing redundancy instead of a resilience introduced as in schemes using the fixed hopping sequence.

FIG. 3 is a schematic overview illustrating an example of actions, performed by the network node 12, for the frequency band selection based on the sequence, according to embodiments herein. The sequence is based on the dynamically adjustable configuration. As mentioned above the at least one first frequency band may be used for robust performance and the at least one second frequency band may be used for probing.

At a starting point, A is member of a robust set and B-E are members of a probing set. The robust set and the probing set are available frequency bands that have been identified by the network node 12.

### Action 301

In time step 1, A and D are selected for transmission of the data. D is measured to have medium quality. The spectrum utilization may be measured by signal strength levels, power spectral density, etc. If the frequency band, e.g. spectrum portion, is not occupied by any other network or if the noise level is low, then the quality is high, and vice versa. Both desired signals and unwanted interference may be measured. The degree of reliability, e.g. packet loss ratio etc., may also allow inferring implicitly about an interference and/or noise situation in the spectrum portion. Besides the signal strength or power measurements, it may also be inferred or indicated explicitly which frequency resource, e.g. bandwidth, has been assigned to the UE 10. If a given bandwidth is assigned to more UEs more often, it can be assumed that it is occupied more often. The same reasoning may also hold for other static spectrum users that, for instance, based on a knowledge that a network uses a particular frequency band, e.g. channel, and it has a given average load, this channel occupancy can be inferred.

### Action 302

In time step 2, the network node 12 selects C from the probing set. C is measured to have low quality.

### Action 303

In time step 3, the network node 12 selects D again from the probing set, now measured to have high quality. D is then being added to the robust set.

### Action 304

In time step 4, B is selected by the network node 12. B is measured to have medium measured quality. The robust set now comprises A and D, and when this information has propagated to the UE 10, the sequence selected by the network node 12 may stop using A and instead use D, while still maintaining high robustness.

### Action 305

In time step 5, D is used instead of A from the robust set, and E is measured to have medium quality.

One benefit of changing active frequency bands within the robust set, e.g. moving to D from A, is that when a certain frequency band is used for communication, it enables more accurate measurements than by measuring on channel state information (CSI) resources. These CSI resources are sparser in time and frequency, so by using the actual data transmission as an input to the measurements, this may provide better results.

This is also valid for the probing set. As the communication is performed on a frequency band in the probing set, rather than just measuring CSI resources, it may make the communication more robust since redundancy is introduced and it may also give better estimates based on the true data communication.

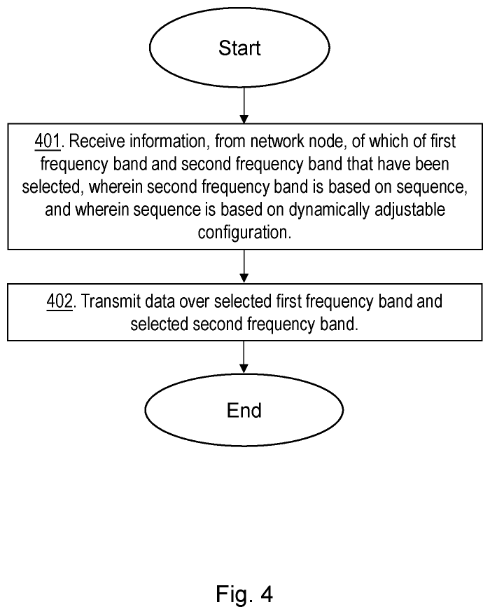

The method actions performed by the UE 10 for handling communication of the data in the communication network 1, according to embodiments herein, will now be described with reference to a flowchart depicted in FIG. 4. The actions do not have to be taken in the order stated below but may be taken in any suitable order.

### Action 401

The UE 10 receives information, from the network node 12, of which of the at least one first frequency band and the at least one second frequency band that have been selected, wherein the at least one second frequency band is based on the sequence, and wherein the sequence is based on the dynamically adjustable configuration.

### Action 402

The UE 10 then transmits the data over the selected at least one first frequency band and the selected at least one second frequency band.

Embodiments herein such as mentioned above will now be further described and exemplified. The text below is applicable to and may be combined with any suitable embodiment described above. According to an example scenario, to increase the reliability, dynamic frequency selection and aggregation may be used, with transmission of the same data over more than one frequency band at the same time. The frequency band can be either a licensed or unlicensed carrier. As mentioned above, the two or more frequency bands to transmit on are typically chosen such that:
one or more bands are chosen as the robust configuration, using the configuration that is expected to deliver robust performance, and
one or more bands are chosen as the probing configuration, using the configuration of bands where channel knowledge is desired.

According to some embodiments, to enable accurate transmission of the data, both the network node 12 and the UE 10 may know what frequency band is being active in a certain time instant. Typically, the frequency selection sequence of the probing and/or robust set may be configured by the network node 12 and informed to the UE 10. This configuration should also be reliable but may not have the same requirements on payload and latency. One approach is to use a licensed band for this control channel. As another example, this may be a dedicated frequency band, e.g. control band, which may be less crowded and more guaranteed, or one or more reliable frequency bands from the identified available frequency bands.

Embodiments herein may be applied both in downlink and uplink. The network node 12 typically determines the sequence, but the UE 10 may in some embodiments be able to assist in the selection of the sequences.

The number of frequency bands used dynamically and adaptively may depend on the QoS requirements as well as the expected quality of the selected bands, that in turn may depend e.g. on the degree of occupancy. As the number of frequency bands increases, the spectrum efficiency goes down as more frequency resources are being used, although this may not be of as much importance in the wide unlicensed frequency ranges. An alternative to the repetition of data over all used frequency bands is to encode the data over all the used frequency bands.

As new frequency bands are being probed, or probed again, the network node 12 may keep track of statistics for different frequency bands. The network node 12 may then choose the hopping sequence of probing and robust bands according to these statistics. For example, simultaneous use of frequency bands with correlated interference, that is, interference that appear at the same time in both frequency bands, can be avoided.

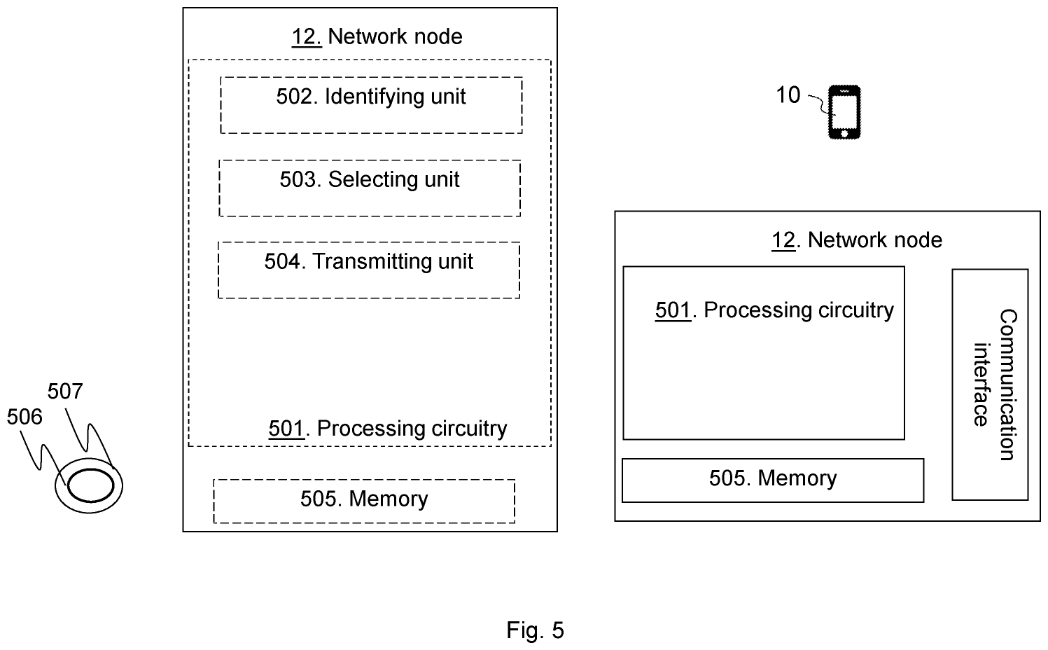

FIG. 5 is a block diagram depicting the network node 12 for handling communication of the data in the communication network 1, according to embodiments herein.

The network node 12 may comprise processing circuitry 501, e.g. one or more processors, configured to perform the methods herein.

The network node 12 may comprise an identifying unit 502. The network node 12, the processing circuitry 501, and/or the identifying unit 502 may be configured to identify the available frequency bands in the communication network and the quality of the respective available frequency band. The at least one first frequency band and/or the at least one second frequency band may be the licensed carrier and/or the unlicensed carrier. The quality of the respective available frequency bands may be associated with one or more of: the lower degree of occupancy, the historically observed higher reliability, the local deployment spectrum policy and the traffic QoS requirements. The available frequency bands may be identified by one or more of: the semi static configuration, predefined in a product, configured in the UE settings, configurable in the UE software. The bandwidth of the first frequency bands and the second frequency bands may be different. The bandwidth of the first frequency bands may be different, and/or the bandwidth of the second frequency bands may be different.

The network node 12 may comprise a selecting unit 503. The network node 12, the processing circuitry 501, and/or the selecting unit 503 is configured to select the at least one first frequency band for transmission of the data, when the quality of the first frequency band is above a threshold value.

The network node 12, the processing circuitry 501, and/or the selecting unit 503 is configured to select the at least one second frequency band for the transmission of the data, based on the sequence, wherein the sequence is based on the dynamically adjustable configuration. The sequence may be known to both the UE 10 and the network node 12. The sequence may be dynamically adjusted when the condition is fulfilled or not, wherein the condition is based on the quality and the knowledge of available frequency bands. The sequence may be semi-static, wherein at least a part of the sequence can be reused. The at least one first frequency band may be used for robust performance, and wherein the second frequency band may be used for probing. The network node 12 may be adapted to inform the UE 10 of which of the first frequency bands and second frequency bands that are selected. The network node 12 may be adapted to inform the UE 10 about the sequence of frequency bands, or parameters specifying the sequence of frequency bands.

The network node 12 may comprise a transmitting unit 504. The network node 12, the processing circuitry 501, and/or the transmitting unit 504 may be configured to transmit the data over the selected at least one first frequency band and the selected at least one second frequency band. The data may be transmitted simultaneously over the at least one first frequency band and the at least one second frequency band. The data may be transmitted uplink and/or downlink. The data transmission may be based on the reliability requirements and/or the quality of the available frequency bands. The data may be transmitted on the licenced carrier or on the dedicated control channel different from the selected first frequency bands and second frequency bands.

The network node 12 further comprises a memory 505. The memory 505 comprises one or more units to be used to store data on, such as data quality, sequence information, bandwidth information, input/output data, metadata, etc. and applications to perform the method disclosed herein when being executed, and similar. The network node 12 may further comprise a communication interface comprising e.g. one or more antenna or antenna elements.

The method according to the embodiments described herein for the network node 12 is implemented by means of e.g. a computer program product 506 or a computer program, comprising instructions, i.e., software code portions, which, when executed on at least one processor, cause the at least one processor to carry out the actions described herein, as performed by the network node 12. The computer program product 506 may be stored on a computer-readable storage medium 507, e.g. a disc, a universal serial bus (USB) stick or similar. The computer-readable storage medium 507, having stored thereon the computer program product, may comprise the instructions which, when executed on at least one processor, cause the at least one processor to carry out the actions described herein, as performed by the network node 12. In some embodiments, the computer-readable storage medium may be a transitory or a non-transitory computer-readable storage medium.

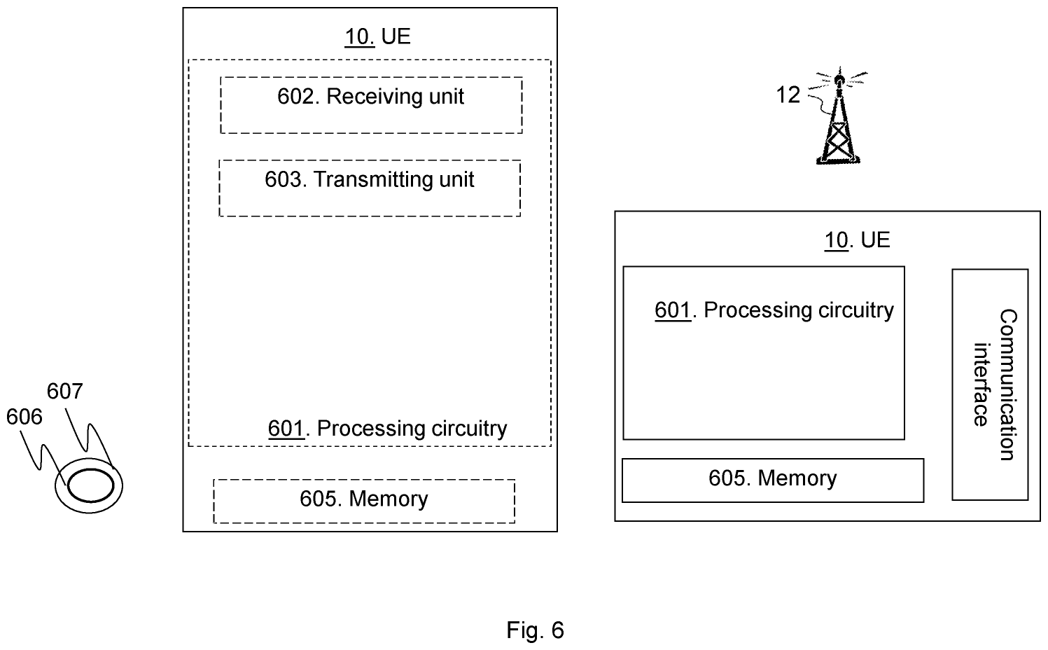

FIG. 6 is a block diagram depicting the network node 12 for handling communication of the data in the communication network 1, according to embodiments herein.

The UE 10 may comprise processing circuitry 601, e.g. one or more processors, configured to perform the methods herein.

The UE 10 may comprise a receiving unit 602. The UE 10, the processing circuitry 601, and/or the receiving unit 602 is configured to receive information, from the network node 12, of which of the at least one first frequency band and the at least one second frequency band that have been selected, wherein the at least one second frequency band is based on the sequence, and wherein the sequence is based on the dynamically adjustable configuration.

The UE 10 may comprise a transmitting unit 603. The UE 10, the processing circuitry 601, and/or the transmitting unit 603 is configured to transmit the data over the selected at least one first frequency band and the selected at least one second frequency band.

The UE 10 further comprises a memory 605. The memory 605 comprises one or more units to be used to store data on, such as data quality, sequence information, bandwidth information, input/output data, metadata, etc. and applications to perform the method disclosed herein when being executed, and similar. The UE 10 may further comprise a communication interface comprising e.g. one or more antenna or antenna elements.

The method according to the embodiments described herein for the UE 10 is implemented by means of e.g. a computer program product 606 or a computer program, comprising instructions, i.e., software code portions, which, when executed on at least one processor, cause the at least one processor to carry out the actions described herein, as performed by the UE 10. The computer program product 606 may be stored on a computer-readable storage medium 607, e.g. a disc, a universal serial bus (USB) stick or similar. The computer-readable storage medium 607, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium.

In some embodiments the general term “network node” is used and it can correspond to any type of radio-network node or any network node, which communicates with a wireless device and/or with another network node. Examples of network nodes are gNodeB, eNodeB, NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or UE is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any radio access technology (RAT) or multi-RAT systems, where the devices receives and/or transmit signals, e.g. data, such as New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMAX), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a UE or network node, for example.

Alternatively, several of the functional elements of the processing units discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### Further Extensions and Variations

With reference to FIG. 7, in accordance with an embodiment, a communication system includes a telecommunication network 3210 such as the wireless communications network 100, e.g. a NR network, such as a 3GPP-type cellular network, which comprises an access network 3211, such as a radio access network, and a core network 3214. The access network 3211 comprises a plurality of base stations 3212a, 3212b, 3212c, such as the radio network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the wireless devices 120 such as a non-AP STA 3291 located in coverage area 3213c is configured to wirelessly connect to, or be paged by, the corresponding base station 3212c. A second UE 3292 e.g. the first or second radio node 110, 120 or such as a non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 7 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

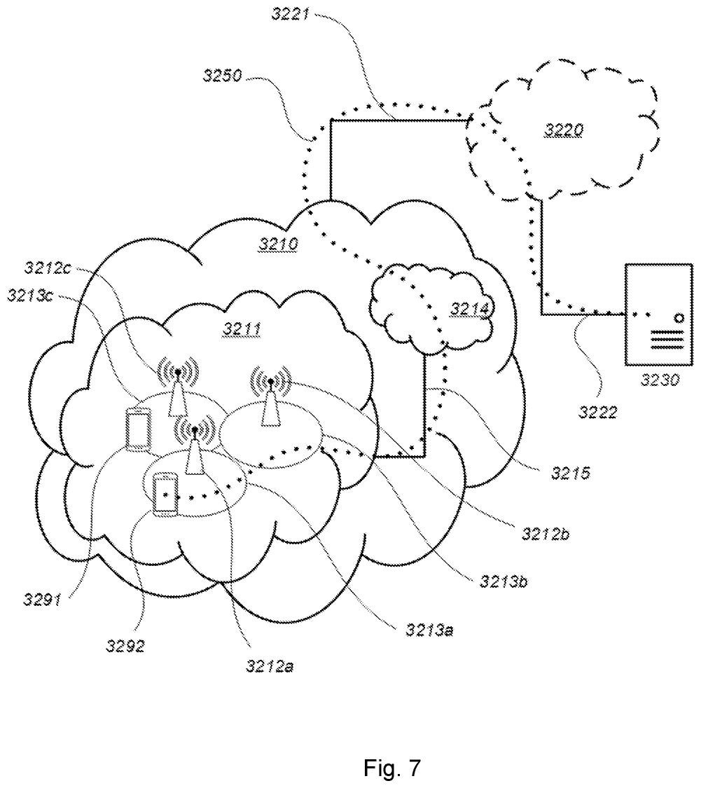

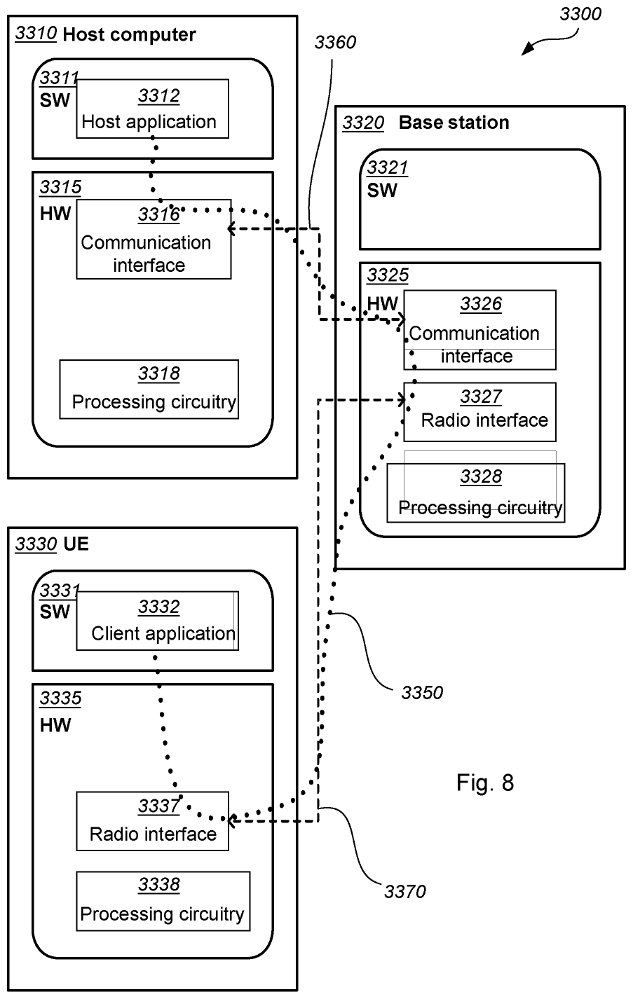

Example implementations, in accordance with an embodiment, of the UE, base station and host computer discussed in the preceding paragraphs will now be described with reference to FIG. 8. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 6) served by the base station 3320. The communication interface 3326 may be configured to facilitate a connection 3360 to the host computer 3310. The connection 3360 may be direct or it may pass through a core network (not shown in FIG. 8) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 8 may be identical to the host computer 3230, one of the base stations 3212a, 3212b, 3212c and one of the UEs 3291, 3292 of FIG. 8, respectively. This is to say, the inner workings of these entities may be as shown in FIG. 8 and independently, the surrounding network topology may be that of FIG. 7.

In FIG. 8, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may enable frequency bands to be selected that show a lower degree of occupancy and thereby improve the communication in the communication network for the UE. This may also lead to extended battery lifetime of the UE.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

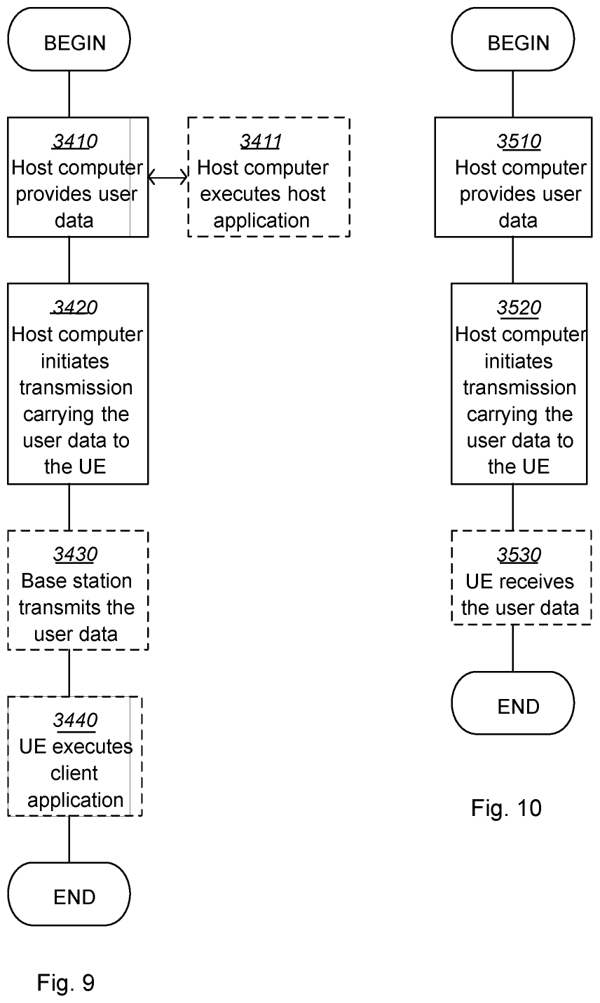

FIG. 9 is a flowchart illustrating a method implemented in a communication system, in accordance with one embodiment. The communication system includes a host computer, a base station such as an AP STA, and a UE such as a non-AP STA which may be those described with reference to FIG. 7 and FIG. 8. For simplicity of the present disclosure, only drawing references to FIG. 9 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 10 is a flowchart illustrating a method implemented in a communication system, in accordance with one embodiment. The communication system includes a host computer, a base station such as an AP STA, and a UE such as a non-AP STA which may be those described with reference to FIG. 7 and FIG. 8. For simplicity of the present disclosure, only drawing references to FIG. 10 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

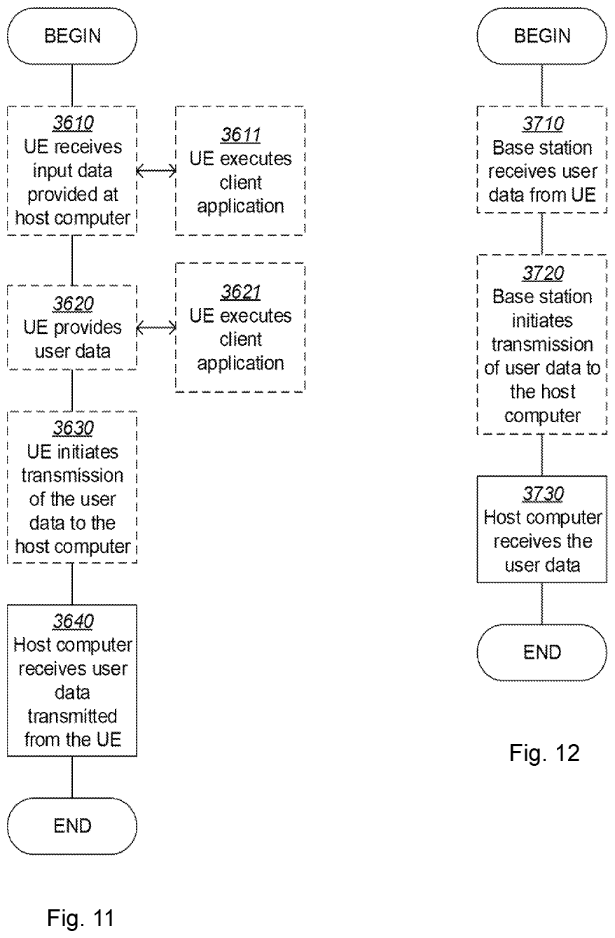

FIG. 11 is a flowchart illustrating a method implemented in a communication system, in accordance with one embodiment. The communication system includes a host computer, a base station such as an AP STA, and a UE such as a non-AP STA which may be those described with reference to FIG. 7 and FIG. 8. For simplicity of the present disclosure, only drawing references to FIG. 11 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station such as an AP STA, and a UE such as a non-AP STA which may be those described with reference to FIG. 7 and FIG. 8. For simplicity of the present disclosure, only drawing references to FIG. 12 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above-described preferred embodiments. Various alternatives, modifications and equivalents may be used.

1. A method performed by a network node for handling communication of data in a communication network, the method comprising:
selecting at least one first frequency band for a transmission of the data, when a quality of the first frequency band is above a threshold value; and
selecting at least one second frequency band for a transmission of the data, based on a sequence, the sequence being based on a dynamically adjustable configuration.

2. The method according to claim 1, wherein the sequence is known to both a user equipment, UE, and the network node.

3. The method according to claim 1, wherein the sequence is dynamically adjusted when a condition fulfilled or not, wherein the condition is based on a quality and a knowledge of available frequency bands.

4. The method according to claim 1, wherein the at least one first frequency band is used for robust performance, and wherein the at least one second frequency band is used for probing.

5. The method according to claim 1, wherein the method further comprises:
identifying available frequency bands in the communication network and a quality of respective available frequency band.

6. The method according to claim 1, wherein the method further comprises:
transmitting the data over the selected at least one first frequency band and the selected at least second frequency band.

7. The method according to claim 6, wherein the data is transmitted simultaneously over the at least one first frequency band and the at least second frequency band.

8. The method according to claim 1, wherein the at least one first frequency band and/or the at least one second frequency band is one or both of a licensed carrier and an unlicensed carrier.

9. The method according to claim 1, wherein the quality of the respective available frequency bands is associated with one or more of: a lower degree of occupancy, a historically observed higher reliability, a local deployment spectrum policy and traffic Quality-of-Service, QoS, requirements.

10. (canceled).

11. The method according to claim 5, wherein the available frequency bands are identified by one or more of: a semi static configuration, predefined in a product, configured in the UE settings, configurable in the UE software.

12. The method according to claim 6, wherein the data transmission is based on one or both of reliability requirements and a quality of available frequency bands.

13. The method according to claim 1, wherein the network node informs the UE of which of the at least one first frequency band and the at least one second frequency band that are selected.

14. The method according to claim 1, wherein the network node informs the UE about the sequence of frequency bands, or parameters specifying the sequence of frequency bands.

15. The method according to claim 6, wherein the data is transmitted on a licenced carrier or on a dedicated control channel different from the selected at least one first frequency band and the at least one second frequency band.

16. The method according to claim 1, wherein the bandwidth of the at least one first frequency band and the at least one second frequency band is different.

17. The method according to claim 1, wherein one or both:
the bandwidth of the at least one first frequency band is different; and
the bandwidth of the at least one second frequency band is different.

18. The method according to claim 1, wherein the sequence is semi-static, wherein at least a part of the sequence can be reused.

19. A method performed by a user equipment, UE, for handling communication of data in a communication network, the method comprising:
receiving information, from the network node, of which of at least one first frequency band and at least one second frequency band that have been selected, wherein the at least one second frequency band is based on a sequence, the sequence being based on a dynamically adjustable configuration; and
transmitting the data over the selected at least one first frequency band and the selected at least one second frequency band.

20. A network node for handling communication of data in a communication network, the network node configured to:
select at least one first frequency band for transmission of the data, when a quality of the first frequency band is above a threshold value; and
select at least one second frequency band for transmission of the data, based on a sequence, the sequence being based on a dynamically adjustable configuration.

21. (canceled).

22. A user equipment, UE, for transmitting data to a network node in a communication network, the UE being configured to:
receive information, from the network node, of which of at least one first frequency band and at least one second frequency band that have been selected, wherein the at least one second frequency band is based on a sequence, the sequence being based on a dynamically adjustable configuration; and
transmit the data over the selected at least one first frequency band and the selected at least one second frequency band.

23. (canceled).

24. (canceled).
